(19) United States
(12) Patent Application Publication
(10) Pub. No.: US 2019/0121268 A1
(43) Pub. Date: Apr. 25, 2019

(54) IMAGE FORMING APPARATUS

(71) Applicant: TOSHIBA TEC KABUSHIKI KAISHA, Tokyo (JP)

(72) Inventor: Katsuya ENDO, Fuji Shizuoka (JP)

(21) Appl. No.: 16/141,760

(22) Filed: Sep. 25, 2018

(30) Foreign Application Priority Data
Oct. 24, 2017 (JP) 2017-205268

(51) Int. Cl. G03G 15/20

(52) U.S. Cl. CPC G03G 15/2039

(57) ABSTRACT

An image forming apparatus includes a heat roller configured to heat a sheet on which a toner image is formed, a plurality of heaters arranged in a main scanning direction, each of the heaters configured to heat one of a plurality of blocks of the heat roller arranged in the main scanning direction, a counter circuit configured to count for each of the blocks of the heat roller, the number of pixels of a toner image which are formed on a region of the sheet heated by the block, and a controller configured to determine for each heater a duty ratio of pulses to be output to the heater according to the number of pixels counted by the counter circuit, and output pulses to each of the heaters according to the duty ratio thereof.

### CROSS-REFERENCE TO RELATED APPLICATION

This application is based upon and claims the benefit of priority from Japanese Patent Application No. 2017-205268, filed Oct. 24, 2017, the entire contents of which are incorporated herein by reference.

### FIELD

Embodiments described herein relate generally to an image forming apparatus.

### BACKGROUND

One type of Multifunction Peripheral (MFP) has a plurality of heaters arranged in the main scanning direction of a thermal head to fix a toner on a sheet. To heat each of the heaters, the controller of the MFP inputs a pulse to a transistor connected to each of the heaters. Thus, a peak power consumption may increase when the controller concurrently inputs a plurality of pulses and their ON periods overlap with each other.

### DESCRIPTION OF THE DRAWINGS

FIG. 1 is a block diagram illustrating an example of a configuration of an image forming apparatus according to an embodiment;

FIG. 2 is a circuit diagram illustrating an example of a configuration of a power sheet supply unit according to an embodiment;

FIG. 3 is a block diagram illustrating an example of a configuration of a fixing unit according to an embodiment;

FIG. 4 is a diagram illustrating an example of a configuration of the fixing unit according to an embodiment;

FIG. 5 is a diagram for explaining an example of an operation of a counter circuit according to an embodiment;

FIG. 6 is a timing chart illustrating an example of pulses output by the fixing unit according to an embodiment; and

FIG. 7 is a diagram illustrating electric power consumed by the fixing unit according to an embodiment.

### DETAILED DESCRIPTION

In accordance with an embodiment, an image forming apparatus comprises a heat roller configured to heat a sheet on which a toner image is formed, a plurality of heaters arranged in a main scanning direction, each of the heaters configured to heat one of a plurality of blocks of the heat roller arranged in the main scanning direction, a counter circuit configured to count for each of the blocks of the heat roller, the number of pixels of a toner image which are formed on a region of the sheet heated by the block, and a controller configured to determine for each heater a duty ratio of pulses to be output to the heater according to the number of pixels counted by the counter circuit, and output pulses to each of the heaters according to the duty ratio thereof.

Hereinafter, an embodiment will be described with reference to the accompanying drawings.

An MFP (more generally, an image forming apparatus) according to an embodiment forms an image on a sheet using a toner. The MFP forms a toner image on the sheet according to the image data to be formed. The MFP heats the sheet on which the toner is formed with a heater to fix the toner on the sheet. The MFP may form an image on the sheet using a black toner. The MFP may form an image on the sheet using toners of a plurality of colors (for example, cyan, magenta, yellow, etc.).

The MFP may acquire an image to be formed on a sheet using a scanner. The MFP may acquire an image from an external device through a communication unit. The MFP may acquire an image from a memory device possessed by a user. A method by which the MFP acquires the image is not limited to a specific method. In an embodiment, the MFP acquires an image to be formed on the sheet using the scanner.

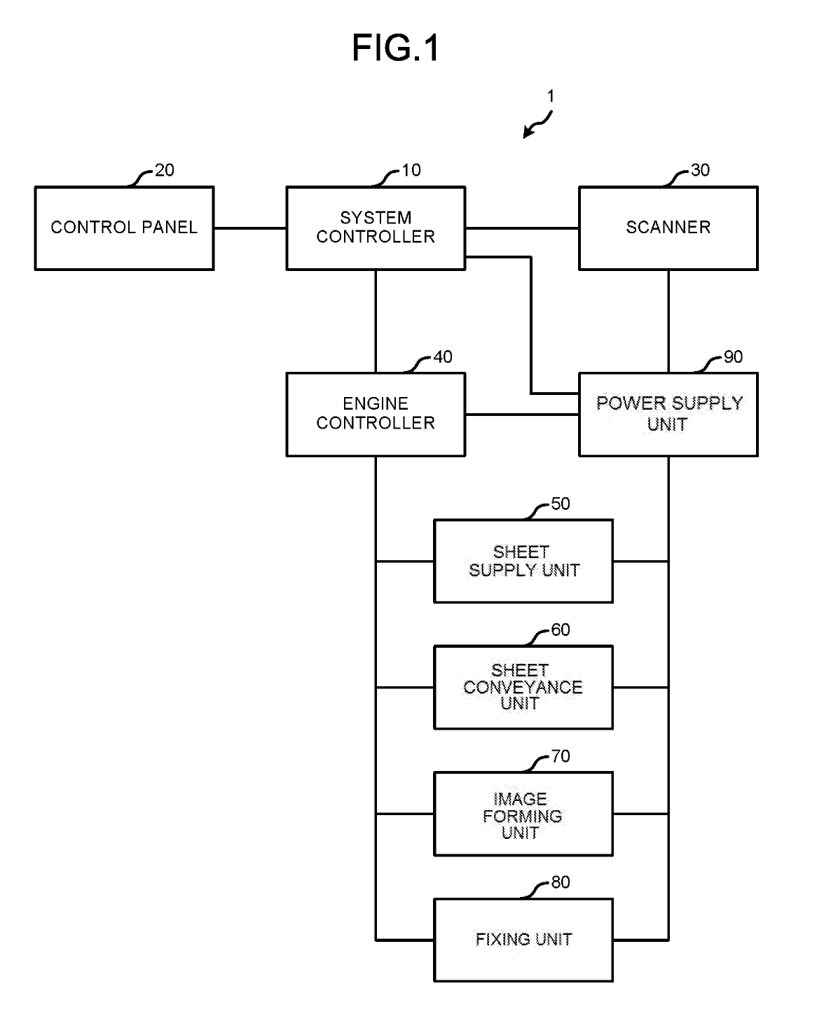

FIG. 1 is a block diagram illustrating an example of a configuration of a MFP 1 according to the embodiment. As shown in FIG. 1, the MFP 1 includes a system controller 10, a control panel 20, a scanner 30, an engine controller 40, a sheet supply unit 50, a sheet conveyance unit 60, an image forming unit 70, a fixing unit 80, and a power supply unit 90.

The system controller 10 is electrically connected to the control panel 20, the scanner 30, the engine controller 40, and the power supply unit 90. The engine controller 40 is electrically connected to the sheet supply unit 50, the sheet conveyance unit 60, the image forming unit 70, the fixing unit 80, and the power supply unit 90. The power supply unit 90 is electrically connected to the scanner 30, the sheet supply unit 50, the sheet conveyance unit 60, the image forming unit 70, and the fixing unit 80.

The MFP 1 may further have a component as required in addition to the components as shown in FIG. 1, or a specific component may be excluded from the MFP 1.

The system controller 10 controls the operation of the entire MFP 1. For example, the system controller 10 receives an input of various operations from a user with the control panel 20. The system controller 10 acquires image data of an image to be printed on a sheet with the scanner 30. The system controller 10 transmits the acquired image data to the fixing unit 80. The system controller 10 controls the sheet supply unit 50, the sheet conveyance unit 60, the image forming unit 70, and the fixing unit 80 through the engine controller 40 to print an image on the sheet. The system controller 10 includes, for example, a processor, a Random Access Memory (RAM), a Read Only Memory (ROM), and a Non-volatile Memory (NVM).

With the control panel 20, various instructions are input by the user. The control panel 20 transmits a signal indicating the instruction input by the user to the system controller 10. The control panel 20 includes, for example, a keyboard, a numeric keypad, and a touch panel.

The control panel 20 displays various kinds of information to the user. The control panel 20 displays a screen showing various kinds of information based on the signal from the system controller 10. The control panel 20 includes, for example, a liquid crystal display.

The scanner 30 reads an image of a document and converts it to image data. The scanner 30 comprises, for example, a Charge-coupled Device (CCD) line sensor for converting an image on a reading surface of the document to image data. The CCD line sensor comprises optical sensors arranged side by side in a main scanning direction. The scanner 30 scans the surface of the document in a direction (e.g., the sub-scanning direction) orthogonal to the main scanning direction using the CCD line sensor to read an image on the document as the image data. The scanner 30 may read the image of the document as a color image or may read the image of the document as a monochrome image.

The scanner 30 may scan a document placed on a document table glass. The scanner 30 may read an image of a document conveyed by an Auto Document Feeder (ADF). The scanner 30 outputs the image data of the document to the system controller 10.

The engine controller 40 controls the sheet supply unit 50, the sheet conveyance unit 60, the image forming unit 70, and the fixing unit 80 according to a signal from the system controller 10. The engine controller 40 transmits a signal for instructing the operation to the sheet supply unit 50, the sheet conveyance unit 60, the image forming unit 70, and the fixing unit 80 according to the signal from the system controller 10. The engine controller 40 may transmit signals from the sheet supply unit 50, the sheet conveyance unit 60, the image forming unit 70, and the fixing unit 80 to the system controller 10. For example, the engine controller 40 comprises a processor, a RAM, a ROM, a NVM, and the like. The engine controller 40 may be hardware such as a sequencer circuit.

The sheet supply unit 50 supplies a sheet according to the signal from the engine controller 40. For example, the sheet supply unit 50 includes a cassette for storing the sheet and a pickup roller for taking out sheets one by one from the cassette. The cassette is opened to the outside, and in this way, the user puts a predetermined sheet therein. The pickup roller takes out the sheets one by one from the cassette. The pickup roller supplies the sheet taken out to the sheet conveyance unit 60. The sheet supply unit 50 may be a manual feed tray.

The sheet conveyance unit 60 conveys the sheet supplied from the sheet supply unit 50 in the MFP 1. The sheet conveyance unit 60 conveys the sheet to the image forming unit 70 and the fixing unit 80. The sheet conveyance unit 60 conveys the sheet in the sub-scanning direction. For example, the sheet conveyance unit 60 includes a registration roller, a conveyance belt and the like.

The image forming unit 70 forms a toner image on the sheet based on the image data. The image forming unit 70 applies the toner to the sheet according to the image data. For example, the image forming unit 70 includes a photoconductive drum, an exposure unit, a developing unit, and a transfer belt.

The photoconductive drum is charged by a charging circuit. A potential of the photoconductive drum is reduced by laser light from the exposure unit. In other words, the photoconductive drum is exposed by the laser light. The exposure unit forms an electrostatic latent image on the photoconductive drum with the laser light. The exposure unit irradiates the photoconductive drum with laser light controlled according to the image data with an optical system such as a polygon mirror. The laser light from the exposure unit forms the electrostatic latent image on the surface of the photoconductive drum.

The developing unit develops the electrostatic latent image formed on the photoconductive drum with the toner. For example, the toner accumulates in a region where the potential is low on the photoconductive drum. The developing unit has toners of predetermined colors. The developing unit supplies the toner to the photoconductive drum on which the electrostatic latent image is formed to develop the electrostatic latent image with the toner.

The transfer belt is an intermediate transfer member of a toner image. Specifically, the toner image formed on the photoconductive drum is transferred onto the transfer belt. The transfer belt further transfers the transferred toner image onto the sheet to form the image on the sheet with the toner.

In the case of forming a monochrome image, the image forming unit 70 includes a developing unit having monochrome toner and a photoconductive drum on which a monochrome toner image is formed. In the case of forming a color image, the image forming unit 70 includes developing units having toners of cyan, magenta and yellow, respectively, and photoconductive drums on which toner images of respective colors are formed.

The fixing unit 80 fixes the toner image on the sheet by applying heat to the sheet. The fixing unit 80 is described in detail later.

The power supply unit 90 is a circuit that supplies electric power to the system controller 10, the scanner 30, the engine controller 40, the sheet supply unit 50, the sheet conveyance unit 60, the image forming unit 70, and the fixing unit 80. The power supply unit 90 converts an AC voltage supplied from an external source to a DC voltage and supplies it to each component of the image forming apparatus. The power supply unit 90 may supply electric power to respective components with various voltages. The control panel 20 may receive the electric power from the system controller 10 or may receive the electric power from the power supply unit 90.

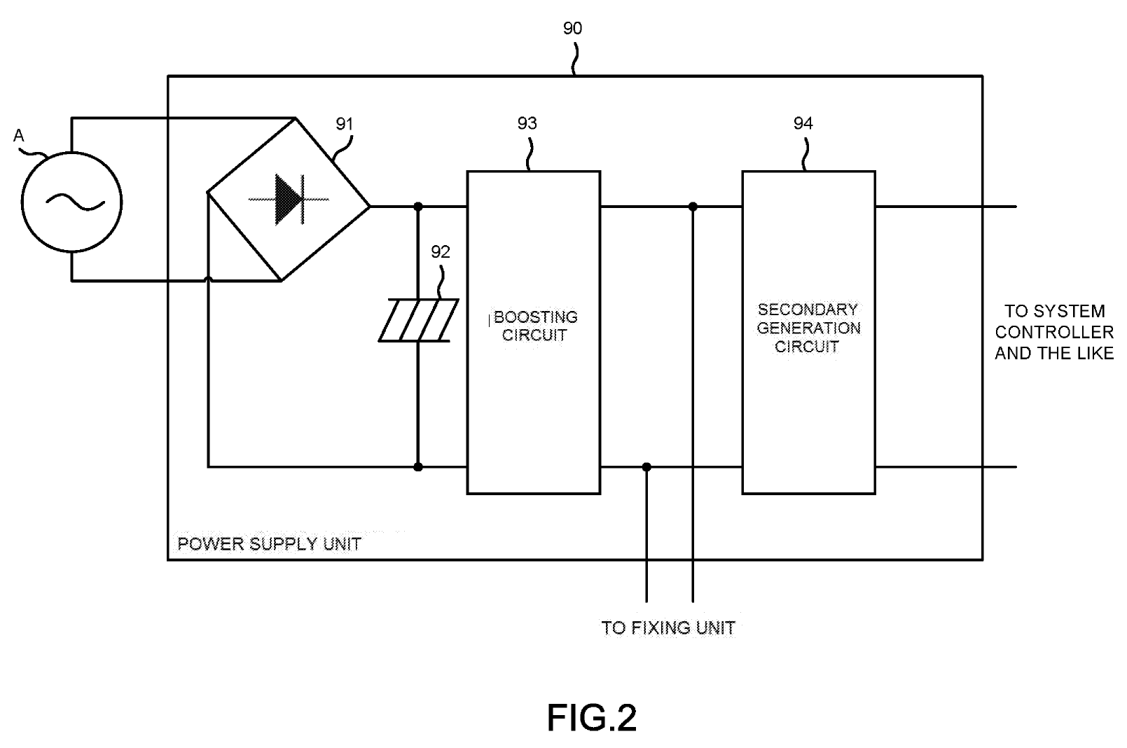

FIG. 2 is a circuit diagram illustrating a configuration of the power supply unit 90. The power supply unit 90 converts an AC voltage from an AC power supply A to a DC voltage. As shown in FIG. 2, the power supply unit 90 includes a rectifying circuit 91, a capacitor 92, a boosting circuit 93, a secondary generation circuit 94, and the like. The power supply unit 90 may further include a component as required in addition to the components as shown in FIG. 2, or a specific component may be excluded from the power supply unit 90.

The AC power supply A supplies the AC voltage. For example, the AC power supply A is a commercial power supply. For example, the AC power supply A is 100 V and supplies an AC voltage that is 50 Hz or 60 Hz. The AC power supply A supplies the AC voltage to the rectifying circuit 91.

The rectifying circuit 91 is connected to the AC power supply A. The rectifying circuit 91 rectifies the AC current from the AC power supply A to output the DC voltage. For example, the rectifying circuit 91 is a bridge rectifying circuit such as a diode or the like.

The capacitor 92 is connected in parallel to output terminals of the rectifying circuit 91. The capacitor 92 levels the DC voltage output by the rectifying circuit 91.

The boosting circuit 93 increases the DC voltage leveled by the capacitor 92 to a predetermined voltage. The boosting circuit 93 outputs the boosted DC voltage to the fixing unit 80 and the secondary generation circuit 94. The boosting circuit 93 may include a diode or the like, and may function as the rectifying section.

The secondary generation circuit 94 adjusts the DC voltage increased by the boosting circuit 93 to a predetermined voltage. The secondary generation circuit 94 supplies the adjusted DC voltage to the system controller 10, the scanner 30, the engine controller 40, the sheet supply unit 50, the sheet conveyance unit 60, and the image forming unit 70. The secondary generation circuit 94 may supply different DC voltages for the system controller 10, the scanner 30, the engine controller 40, the sheet supply unit 50, the sheet conveyance unit 60, and the image forming unit 70, respectively.

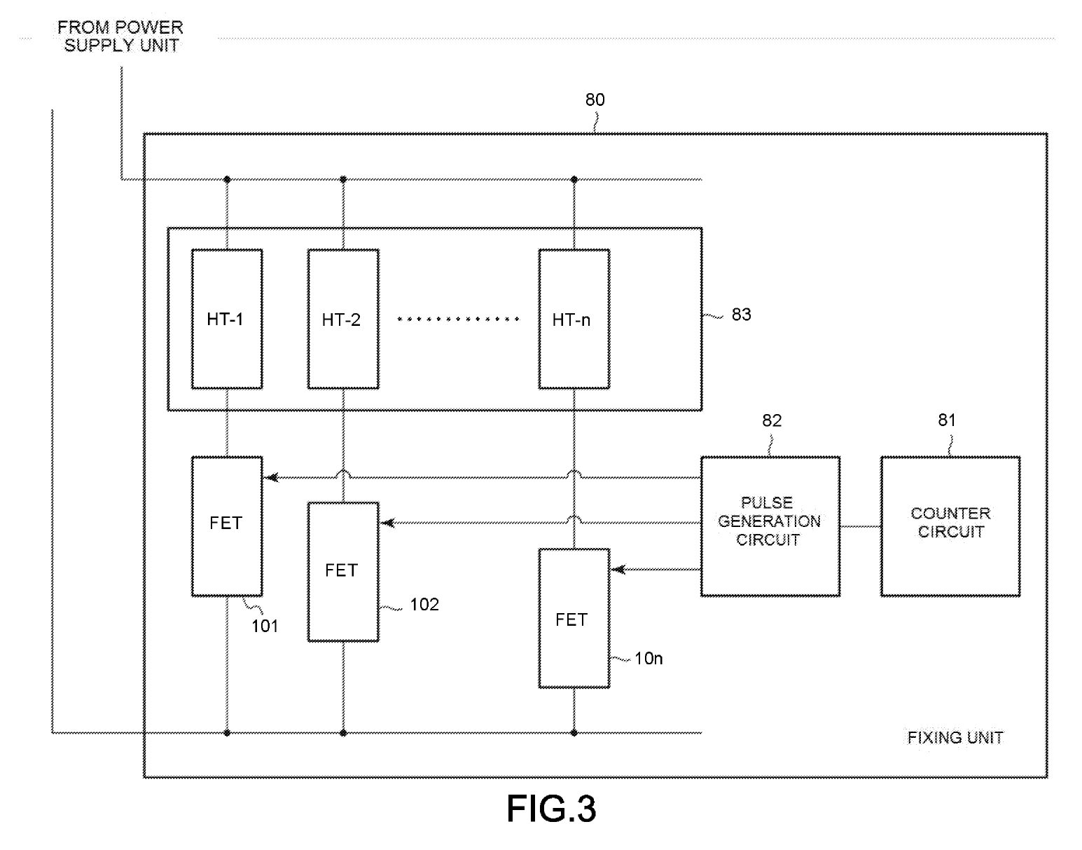

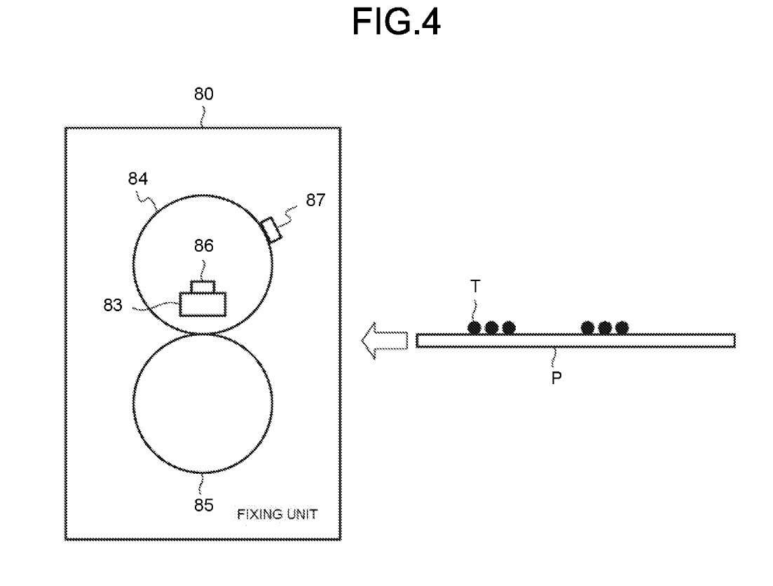

The fixing unit 80 is described below. FIG. 3 is a block diagram illustrating an example of a configuration of the fixing unit 80. FIG. 4 is a diagram illustrating the structure of the fixing unit 80. As shown in FIG. 3 and FIG. 4, the fixing unit 80 includes a counter circuit 81, a pulse generation circuit 82, a heater 83, a heat roller 84, a pressure roller 85, a temperature sensor 86, a temperature sensor 87, and FETs 101 to 10n. The fixing unit 80 may further include a component as required in addition to the components as shown in FIG. 3 and FIG. 4, or a specific component may be excluded from the fixing unit 80.

The heater 83 generates the heat based on a signal from the engine controller 40. As shown in FIG. 3, the heater 83 includes heaters HT-1 to HT-n. The heaters HT-1 to HT-n are arranged side by side in the main scanning direction.

The heater HT-1 generates heat with the electric power from the power supply unit 90. The heater HT-1 is, for example, a heater lamp such as a halogen lamp. Since the heaters HT-2 to HT-n have the same configuration as the heater HT-1, description thereof is omitted.

One ends of the heaters HT-1 to HT-n are connected to the FETs 101 to 10n, respectively.

Field Effect Transistors (FETs) 101 to 10n are energized based on the pulse from the pulse generation circuit 82.

The FET 101 is formed between the power supply unit 90 and the heater HT-1. If a pulse is input, the FET 101 energizes the power supply unit 90 and the heater HT-1. In other words, if the pulse is input to the FET 101, the heater HT-1 receives the electric power from the power supply unit 90 to generate heat.

Since the FETs 102 to 10n have the same configuration as the heater HT-1, the description thereof is omitted.

The heat roller 84 heats a toner T to fix the toner T on a sheet P. The heat roller 84 is a roller extending to a predetermined length in the main scanning direction. The heat roller 84 conveys the sheet P conveyed in the sub-scanning direction while sandwiching the sheet P between the pressure roller 85 and the heat roller 84. The heat roller 84 heats the toner T on the sheet P while conveying the sheet P.

The heat roller 84 includes the heater 83 therein. The heat roller 84 is heated with the heat generated by the heater 83. In an embodiment, the heater 83 comprises a plurality of heaters HT-1 to HT-n arranged in the main scanning direction, and the heat roller 84 is heated by the heaters HT-1 to HT-n. The surface of the heat roller 84 is divided into a plurality of blocks B-1 to B-n. The blocks B-1 to B-n are regions heated by the heaters HT-1 to HT-n, respectively.

The heat roller 84 may rotate by a driving force from a driving section such as a motor. The heat roller 84 may be driven to rotate by the rotation of the pressure roller 85.

The pressure roller 85 contacts with the heat roller 84 while applying pressure on the heat roller 84. The pressure roller 85 conveys the sheet P between the heat roller 84 and the pressure roller 85. The pressure roller 85 may rotate by a driving force from a driving section such as a motor. The pressure roller 85 may be driven to rotate by the rotation of the heat roller 84.

The temperature sensor 86 measures a temperature of the heater 83. The temperature sensor 86 is installed in the heater 83 or in the vicinity of the heater 83. For example, the temperature sensor 86 may measure the temperature of each of the heaters HT-1 to HT-n. The temperature sensor 86 may measure a temperature of a region including several heaters HT (heaters HT-1 to HT-n). For example, the temperature sensor 86 is a thermistor, an infrared sensor or the like. The configuration of the temperature sensor 86 is not limited to a specific configuration. The temperature sensor 86 transmits the measured temperature to the pulse generation circuit 82.

The temperature sensor 87 measures the temperature of the heat roller 84. The temperature sensor 87 is installed in the heat roller 84 or in the vicinity of the heat roller 84. For example, the temperature sensor 87 is a thermistor, an infrared sensor, or the like. The configuration of the temperature sensor 87 is not limited to a specific configuration. The temperature sensor 87 transmits the measured temperature to the pulse generation circuit 82.

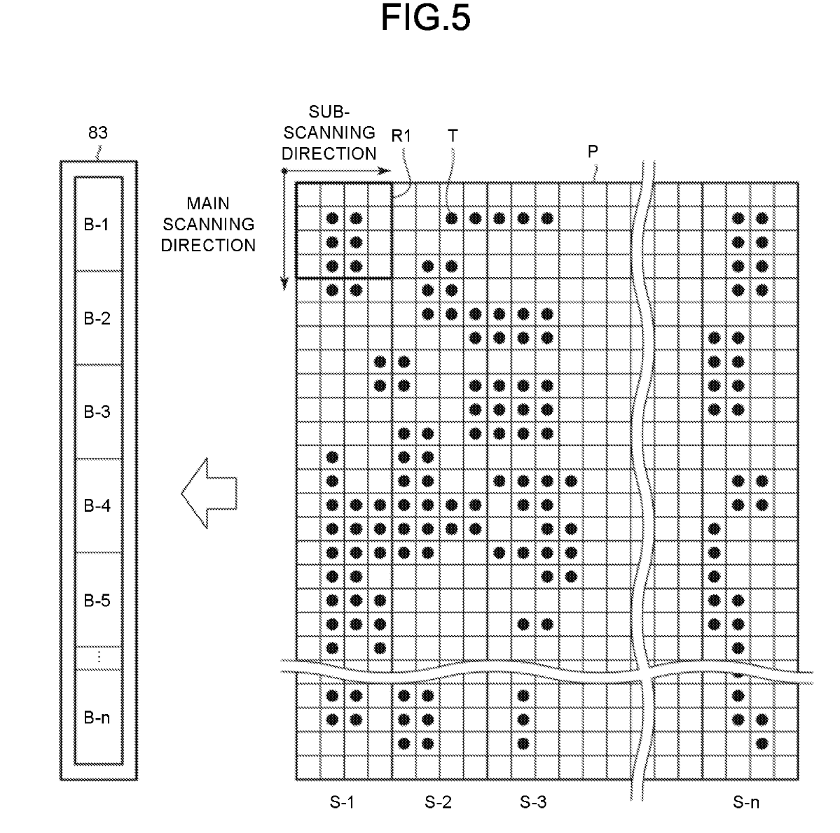

The counter circuit 81 counts the number of pixels of the toner image within each region R obtained by dividing ranges heated by respective blocks B-1 to B-n at predetermined intervals in the sub-scanning direction on the sheet P. FIG. 5 is a diagram illustrating an example of the operation of the counter circuit 81.

As shown in FIG. 5, the counter circuit 81 divides the entire area of the sheet P into a plurality of sections in the sub-scanning direction. Here, the counter circuit 81 divides the entire area of the sheet Pinto sections S-1 to S-n. A width of the section S (S-1 to S-n) is a distance by which the sheet P is conveyed at a predetermined period of time. In other words, the width of the section S is a distance by which the sheet P passes through the heat roller 84 at the predetermined period of time.

The counter circuit 81 divides the entire area of the sheet P by each block B and each section S. In other words, the counter circuit 81 divides a range heated by each block B for each section S.

The counter circuit 81 counts the number of pixels of the toner image formed in a region R divided for each block B and each section S. In other words, the counter circuit 81 counts the number of pixels of the toner image formed in a part heated by each block B on the sheet P for each width of the section S.

For example, the counter circuit 81 counts the number of pixels in a region R1 on the sheet P. As shown in FIG. 5, the region R1 is a region included in the section S-1 and heated by the block B-1. The counter circuit 81 counts the number of pixels in the region R1 (block B-1 and section S-1) up to “6”. The counter circuit 81 counts the number of pixels in each region of the sheet P.

The counter circuit 81 transmits the counted number of pixels to the pulse generation circuit 82.

The counter circuit 81 may be realized by the processor executing the program. The counter circuit 81 may be realized by hardware such as a sequencer circuit.

The pulse generation circuit 82 controls the heaters HT-1 to HT-n based on the number of pixels in respective regions R counted by the counter circuit 81. The pulse generation circuit 82 controls each of the heaters HT-1 to HT-n using Pulse Width Modulation (PWM). The pulse generation circuit 82 outputs pulses to the FETs 101 to 10n based on the number of pixels. The pulse generation circuit 82 outputs pulses for appropriately heating the regions according to the number of pixels in respective regions R of the sheet P.

Based on the number of pixels in a predetermined region R of the sheet P, the pulse generation circuit 82 outputs the pulse to the FET connected to the heater HT of the block B corresponding to the region R at a timing at which the heater HT heats the block B. For example, the pulse generation circuit 82 outputs the pulse to the FET at a timing at which the sheet P is conveyed and the region R contacts with the block B or a predetermined period of time (e.g., several tens of milliseconds) before the timing at which the region R contacts with the block B.

The pulse generation circuit 82 sets a duty ratio (a ratio to the maximum output of the heater HT) for heating the heater HT for each region R of the sheet P. For example, the pulse generation circuit 82 sets “80%” as the duty ratio in the region R if the number of pixels of a certain region R is equal to or more than a predetermined threshold value.

For example, the pulse generation circuit 82 sets “40%” as a duty ratio for a certain region R if the number of pixels of the region R is equal to or less than a predetermined threshold value.

The pulse generation circuit 82 may set the duty ratio based on other factors. For example, the pulse generation circuit 82 may set the duty ratio based on a heat capacity of the heat roller 84, a melting point of the toner, a structure of the fixing unit 80, or the like.

The pulse generation circuit 82 may set the duty ratio further based on the temperature of the heater 83 and the temperature of the heat roller 84. For example, the pulse generation circuit 82 may set the duty ratio to a small value if the temperature of the heater 83 or the temperature of the heat roller 84 is relatively high. For example, the pulse generation circuit 82 may set the duty ratio to a large value if the temperature of the heater 83 or the temperature of the heat roller 84 is relatively low.

The pulse generation circuit 82 may set a current duty ratio based on the duty ratio set in the past (the duty ratio set for the section S in the past). The pulse generation circuit 82 may set the duty ratio of a region (a region R in the same block B but in a section S following the section S of the predetermined region R) following the predetermined region R based on the duty ratio set in the predetermined region R in the past.

For example, if a relatively large duty ratio is set for the predetermined region R, the pulse generation circuit 82 may set a relatively small duty ratio for the following region R.

The pulse generation circuit 82 may set a duty ratio for a predetermined region R based on duty ratios of other regions R (regions R in the same section S) which are simultaneously heated. For example, the pulse generation circuit 82 sets the duty ratio of the predetermined region R based on the adjacent regions R.

For example, the pulse generation circuit 82 may set a relatively small duty ratio for the predetermined region R when the duty ratio of the adjacent region R is relatively large. The pulse generation circuit 82 may set a relatively large duty ratio for the predetermined region R when the duty ratio of the adjacent region R is relatively small.

The method by which the pulse generation circuit 82 sets the duty ratio is not limited to a specific configuration.

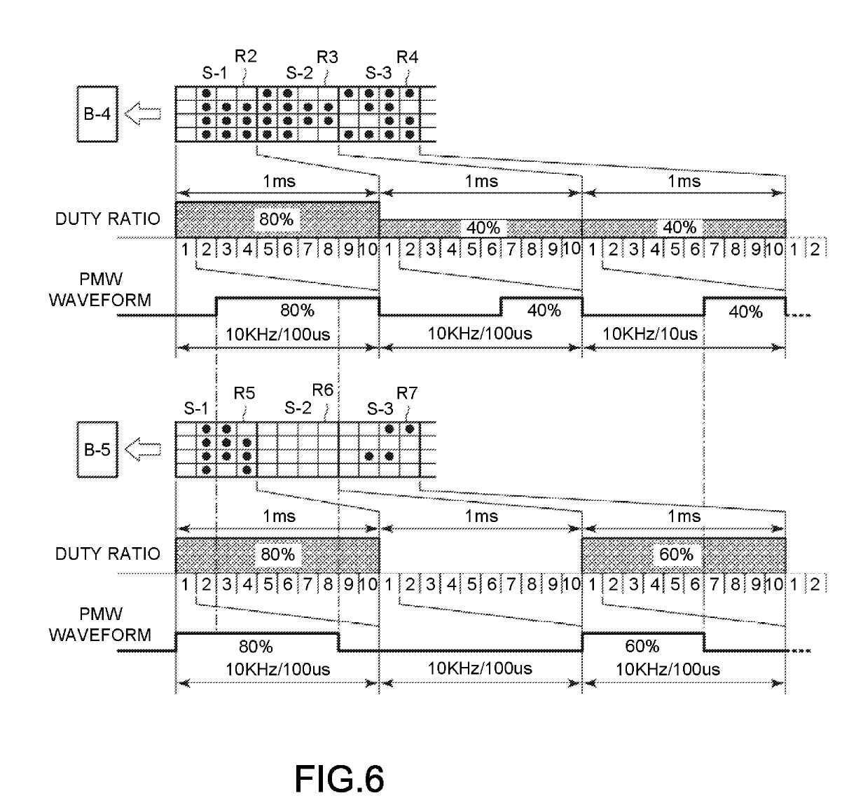

Next, the pulse output by the pulse generation circuit 82 is described. FIG. 6 is a timing chart illustrating an example of pulses output by the pulse generation circuit 82. FIG. 6 shows an example of pulses that the pulse generation circuit 82 outputs to the FEFs 104 and 105 corresponding to the blocks B-4 and B-5.

The pulse generation circuit 82 outputs a plurality of pulses for one region R. Here, the pulse generation circuit 82 outputs ten pulses for each region R. The pulse generation circuit 82 outputs the pulses at a predetermined frequency. Here, the pulse generation circuit 82 generates the pulses at 10 KHz.

The pulse generation circuit 82 generates a left-justified pulse or a right-justified pulse. Here, the left-justified pulse refers to a pulse which rises simultaneously at the beginning of a pulse output period. The right-justified pulse refers to a pulse which falls simultaneously at the end of the pulse output period. The timing at which the right-justified pulse rises is not limited to a specific timing as long as it rises at a timing different from the left-justified pulse.

The pulse generation circuit 82 outputs the left-justified pulse for controlling a part (first heaters) of the plurality of heaters HT, and outputs the right-justified pulse for controlling the other heaters (second heaters) other than the above-mentioned part of the plurality of heaters HT.

Here, the pulse generation circuit 82 alternately outputs the left-justified pulse and the right-justified pulse to the FETs 101 to 10n. The heaters HT (first heaters) controlled by the left-justified pulse and the heaters HT (second heaters) controlled by the right-justified pulse are alternately arranged.

Here, the pulse generation circuit 82 outputs the left-justified pulse to the odd-numbered FETs (FETs 101, 103, 105 . . . ). The pulse generation circuit 82 outputs right-justified pulse to even-numbered FETs (FETs 102, 106, 108 . . . ).

First, the pulse that the pulse generation circuit 82 outputs to the FET 104 corresponding to the block B-4 is described.

As shown in FIG. 6, the pulse generation circuit 82 sets “80%” as the duty ratio set for a region R2 (block B-4, section S-1). Therefore, the pulse generation circuit 82 outputs a pulse with a width which is 80% of the maximum width to the FET 104 corresponding to the region R2. The pulse generation circuit 82 outputs the right-justified pulse to the FET 104.

The pulse generation circuit 82 sets “40%” as the duty ratio set for a region R3 (block B-4, section S-2). Therefore, the pulse generation circuit 82 outputs a pulse with a width which is 40% of the maximum width to the FET 104 corresponding to the region R3. Likewise, the pulse generation circuit 82 outputs the right-justified pulse to the FET 104.

The pulse generation circuit 82 sets “40%” as the duty ratio set for a region R4 (block B-4, section S-3). Therefore, the pulse generation circuit 82 outputs a pulse with a width which is 40% of the maximum width to the FET 104 corresponding to the region R4. Likewise, the pulse generation circuit 82 outputs the right-justified pulse to the FET 104.

Next, the pulse output by the pulse generation circuit 82 to the FET 105 corresponding to the block B-5 is described.

As shown in FIG. 6, the pulse generation circuit 82 sets “80%” as the duty ratio set for a region R5 (block B-5, section S-1). Therefore, the pulse generation circuit 82 outputs a pulse with a width which is 80% of the maximum width to the FET 105 corresponding to the region R5. The pulse generation circuit 82 outputs the left-justified pulse to the FET 105.

The pulse generation circuit 82 sets “0%” as the duty ratio set for a region R6 (block B-5, section S-2). Therefore, the pulse generation circuit 82 does not output a pulse to the FET 105 corresponding to the region R6.

The pulse generation circuit 82 sets “60%” as the duty ratio set for a region R7 (block B-5, section S-3). Therefore, the pulse generation circuit 82 outputs a pulse with a width which is 60% of the maximum width to the FET 105 corresponding to the region R7. Similarly, the pulse generation circuit 82 outputs the left-justified pulse to the FET 105.

The pulse generation circuit 82 may be realized by the processor executing a program. The pulse generation circuit 82 may be realized by hardware such as a sequencer.

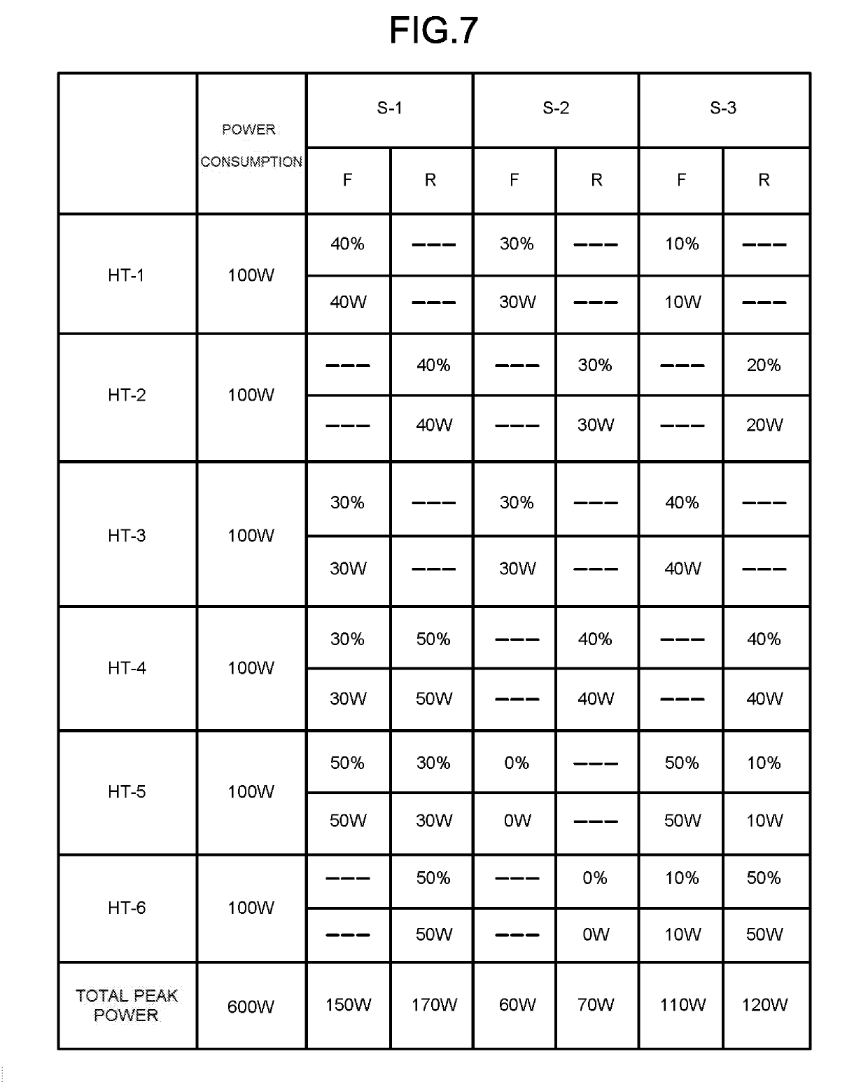

Next, the electric power consumed by each heater HT is described. FIG. 7 is a table for explaining the electric power consumed by each heater HT. Here, it is assumed that the maximum output of each heater HT is 100 W. The table shown in FIG. 7 shows the electric power of a former half (F) and a latter half (R) in the pulse output section, respectively.

For example, in the table, it is shown that the pulse generation circuit 82 sets the duty ratio “40%” for the region R1 (block B-1 (heater HT-1), section S-1) and the heater HT-1 consumes 40 W in the former half.

“80%” is set as the duty ratio for the region R2 (block B-4 (heater HT-4), section S-1). In the region R2, the right-justified pulse is output. As a result, the pulse is distributed 30% to the former half and 50% to the latter half. Therefore, the table shows that in the region R2, the heater HT-4 consumes 30 W in the former half and consumes 50 W in the latter half.

“80%” is set as the duty ratio for the region R5 (block B-5 (heater HT-5), section S-1). In the region R5, the left-justified pulse is output. As a result, the pulse is distributed 50% to the former half and 30% to the latter half. Therefore, the table shows that in the region R5, the heater HT-5 consumes 50 W in the former half and consumes 30 W in the latter half.

The table shows a total peak power consumed in the former half and the latter half in each section S. For example, the table shows that 150 W is consumed in the former half of the section S-1 and 170 W is consumed in the latter half thereof.

The pulse generation circuit 82 may output left-justified, intermediate, and right-justified pulses. For example, the pulse generation circuit 82 outputs the left-justified pulse to (3n-2)th FETs (FET 101, 104, 107 . . . ). The pulse generation circuit 82 outputs an intermediate pulse (a pulse in which center of the pulse output section is high) to the (3n-1) th FETs (FET 102, 105, 108 . . . ). The pulse generation circuit 82 outputs the right-justified pulse to the 3n-th FETs (FET 103, 106, 109 . . . ).

The pulse generation circuit 82 may alternately output the left-justified pulse and the right-justified pulse for each of a plurality of FETs. For example, the pulse generation circuit may switch between the left-justified pulse and the right-justified pulse every 10 pulses. For example, the pulse generation circuit 82 may output the left-justified pulse to the FETs 101 to 110 and output right-justified pulse to the FETs 111 to 120.

The counter circuit 81 and the pulse generation circuit 82 may be integrally formed. The counter circuit 81 and the pulse generation circuit 82 may be integrally realized by the processor executing the program. The counter circuit 81 and the pulse generation circuit 82 may be hardware such as a sequencer. The fixing unit 80 may not have the temperature sensor 86 or 87.

The MFP configured as described above has a plurality of heaters arranged side by side in the main scanning direction. The MFP divides the sheet into regions corresponding to each heater. The MFP also divides the sheet in the sub-scanning direction. The MFP counts the number of pixels of the toner image formed in each region of the sheet. The MFP uses the pulse to control the heater that heats the region based on the number of pixels or the like. As a result, the MFP can properly heat each region.

The MFP outputs the left-justified pulse and right-justified pulse to FETs of the plurality of heaters to control the heaters. As a result, the MFP can prevent each heater from being turned on at the same time. Therefore, the MFP can suppress the peak of power consumption.

The MFP alternately outputs the left-justified pulse and the right-justified pulse to the FETs of the plurality of heaters. As a result, the MFP can turn on the adjacent heater during the period in which the predetermined heater is turned off. Therefore, the MFP can generate heat with the heater adjacent to the heater that is turned off. The MFP can uniformly heat the heat roller.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a heat roller configured to heat a sheet on which a toner image is formed;
a plurality of heaters arranged in a main scanning direction, each of the heaters configured to heat one of a plurality of blocks of the heat roller arranged in the main scanning direction;
a counter circuit configured to count for each of the blocks of the heat roller, the number of pixels of a toner image which are formed on a region of the sheet heated by the block; and
a controller configured to determine for each heater a duty ratio of pulses to be output to the heater according to the number of pixels counted by the counter circuit, and output pulses to each of the heaters according to the duty ratio thereof.

2. The image forming apparatus according to claim 1, wherein
the heaters comprise a first and a second heater,
the first and the second heater are configured to heat a first and a second block of the heat roller, respectively, and
the controller is configured to output a first and a second pulse to the first and the second heater according to a first and a second duty ratio, respectively.

3. The image forming apparatus according to claim 2, wherein
the controller is configured to output to the second heater the second pulse that is different from the first pulse.

4. The image forming apparatus according to claim 3, wherein
the first block is adjacent to the second block in the main scanning direction.

5. The image forming apparatus according to claim 4, wherein
the first pulse is a left-justified pulse, and
the second pulse is a right-justified pulse.

6. The image forming apparatus according to claim 5, wherein
the left-justified pulse and the right-justified pulse are used alternately in the blocks arranged in the main scanning direction.

7. The image forming apparatus according to claim 1, wherein
the counter circuit is configured to count the total number of pixels in the region in a second direction perpendicular to the main scanning direction.

8. The image forming apparatus according to claim 7, wherein
the second direction is a sub-scanning direction of the image forming apparatus.

9. The image forming apparatus according to claim 8, wherein
the region is defined based on a predetermined distance on the sheet conveyed in a predetermined time period in the sub-scanning direction.

10. The image forming apparatus according to claim 9, wherein
a width of the region in the sub-scanning direction is a distance by which the sheet passes through the heat roller in the predetermined time period in the sub-scanning direction.

11. The image forming apparatus according to claim 1, further comprising:
a sensor configured to measure a temperature of each heater, wherein
the controller is configured to output the pulses based on the measured temperature.

12. The image forming apparatus according to claim 11, wherein
the controller is configured to output the pulses having different duty ratios based on the measured temperature.

13. The image forming apparatus according to claim 12, wherein
the controller is configured to output a pulse having a greater duty ratio for a lower temperature measured by the sensor.

14. The image forming apparatus according to claim 1, wherein
the controller is configured to determine for each heater the duty ratio that is different from a duty ratio that has been used to heat the heater.

15. The image forming apparatus according to claim 14, wherein
the controller is configured to output a pulse having a greater duty ratio for a smaller duty ratio that has previously been used.

16. The image forming apparatus according to claim 1, wherein
the controller is configured to determine for each heater the duty ratio based on a heat capacity of the heat roller.

17. The image forming apparatus according to claim 1, wherein
the controller is configured to determine for each heater the duty ratio based on a melting point of the toner.

18. The image forming apparatus according to claim 1, wherein
the controller comprises a processor configured to generate the pulses.

19. The image forming apparatus according to claim 1, wherein
the controller comprises a sequencer circuit configured to generate the pulses.

20. An image forming method comprising:
arranging a plurality of heaters in a main scanning direction, each of the heaters facing one of a plurality of blocks of a heat roller that are arranged in the main scanning direction; and
during image forming, counting for each of the blocks of the heat roller, the number of pixels of a toner image which are formed on a region of a sheet that is heated by the block, determining for each heater a duty ratio of pulses to be output to the heater according to the number of pixels counted, and outputting pulses to each of the heaters according to the duty ratio thereof.
